(19) United States
(12) Patent Application Publication
(10) Pub. No.: US 2024/0068180 A1
(43) Pub. Date: Feb. 29, 2024

(54) CONCRETE REMOVAL DEVICE AND SYSTEM

(71) Applicant: Noah Bourdage, Crosby, MN (US)

(72) Inventor: Noah Bourdage, Crosby, MN (US)

(21) Appl. No.: 18/237,198

(22) Filed: Aug. 23, 2023

Related U.S. Application Data
(60) Provisional application No. 63/401,815, filed on Aug. 29, 2022.

(51) Int. Cl. E01C 23/05; B66F 9/075; B66F 9/18

(52) U.S. Cl. CPC E01C 23/05; B66F 9/07504; B66F 9/18

(57) ABSTRACT

The concrete removal device and system which can be used for fast, efficient removal of concrete sidewalks, driveways, slabs and other concrete constructions. A concrete removal device and system includes an operator capable of drilling a concrete slab to set an anchor bolt and driving a forklift equipped with a concrete removal device to elevate a concrete slab to deposit it in a dump truck or dumpster for hauling away from the removal site.

### RELATED APPLICATION

This application claims the benefit of U.S. (Provisional) Application No. 63/401,815 filed Aug. 29, 2022 which is hereby incorporated herein by reference.

### BACKGROUND OF THE INVENTION

The present application relates devices for removal of concrete sidewalks, driveways, slabs, and other concrete constructions.

The removal of concrete sidewalks, driveways, slabs, and other concrete construction can be an enormous task, requiring extensive labor. For example, such a task may require the use of jackhammers, wrecking balls, or other devices to break up the concrete. Front end loaders or other heavy equipment are thereafter needed to scoop up the broken concrete debris for loading into dump trucks that subsequently haul away the broken up concrete. Even a small job may therefore require skilled labor for at least a day.

Accordingly, there is a need for a concrete removal device and system which can be used for fast, efficient removal of concrete sidewalks, driveways, slabs, and other concrete constructions.

### SUMMARY OF THE INVENTION

An apparatus is provided that includes: an angle having a vertical wall and a horizontal wall; and a plurality of gussets each attached to the vertical wall and the horizontal wall of the angle, along a length thereof. The vertical wall has a plurality of slots passing therethrough, each configured to receive a forklift fork, where the horizontal wall has a slot therein located between the holes in the vertical wall, and where the slot in the horizontal wall extends outward from about a center of the horizontal wall to an outer edge thereof.

In one embodiment, the apparatus further includes a pair of channels attached to the vertical wall and the horizontal wall at the slots in the vertical wall, the channels configured for forklift forks to pass through the slots and through a volume created by the channels and the horizontal wall of the angle.

In one embodiment, each of the channels is located on the angle between a pair of gussets.

In one embodiment, the slot in the horizontal wall is located on the angle between a pair of gussets.

In one embodiment, a thickness of the horizontal wall of the angle between the pair of gussets flanking the slot in the horizontal wall is a multiple of a thickness of the horizontal wall between other pairs of gussets.

In one embodiment, at least one of the channels has therein a means for securing the device to at least one forklift fork.

In one embodiment, the angle has a length of between 18 inches and 48 inches.

In one embodiment, the horizontal wall has a second slot therein located between the holes in the vertical wall, and wherein the second slot in the horizontal wall extends outward from about a center of the horizontal wall to an outer end thereof.

In one embodiment, each of the slot in the horizontal wall and the second slot in the horizontal wall are flacked by a pair of gussets.

In one embodiment, the slot in the horizontal wall flares out toward the outer edge of the horizontal wall.

Additional aspects of the present invention will be apparent in view of the description which follows.

### BRIEF DESCRIPTION OF THE FIGURES

The invention(s) disclosed herein may be more completely understood in consideration of the following detailed description of various embodiments of the invention in connection with the accompanying drawings, in which:

FIG. 1 is a side elevation view of the concrete removal device and system in use.

FIG. 2 is a perspective view of a concrete removal device;

FIG. 3 is a front elevation view thereof.

FIG. 4 is a rear elevation view thereof.

FIG. 5 is a left side elevation view thereof.

FIG. 6 is a right side elevation view thereof.

FIG. 7 is a top plan view thereof.

FIG. 8 is a bottom plan view thereof.

FIG. 9 is a perspective view of a second embodiment of a concrete removal device and system.

FIG. 10 is a perspective view of a third embodiment of a concrete removal device.

FIG. 11 is a perspective view of FIG. 10 looking up from the bottom.

FIG. 12 is a perspective view of a fourth embodiment of a concrete removal device.

FIG. 13 is a perspective view of FIG. 12 looking up from the bottom.

While the invention is amenable to various modifications and alternative forms, specifics thereof have been shown by way of example in the drawings and will be described in detail. It should be understood, however, that the intention is not to limit the invention to the particular embodiments described but rather to include all modifications, equivalents, and alternatives.

### DETAILED DESCRIPTION OF THE INVENTION

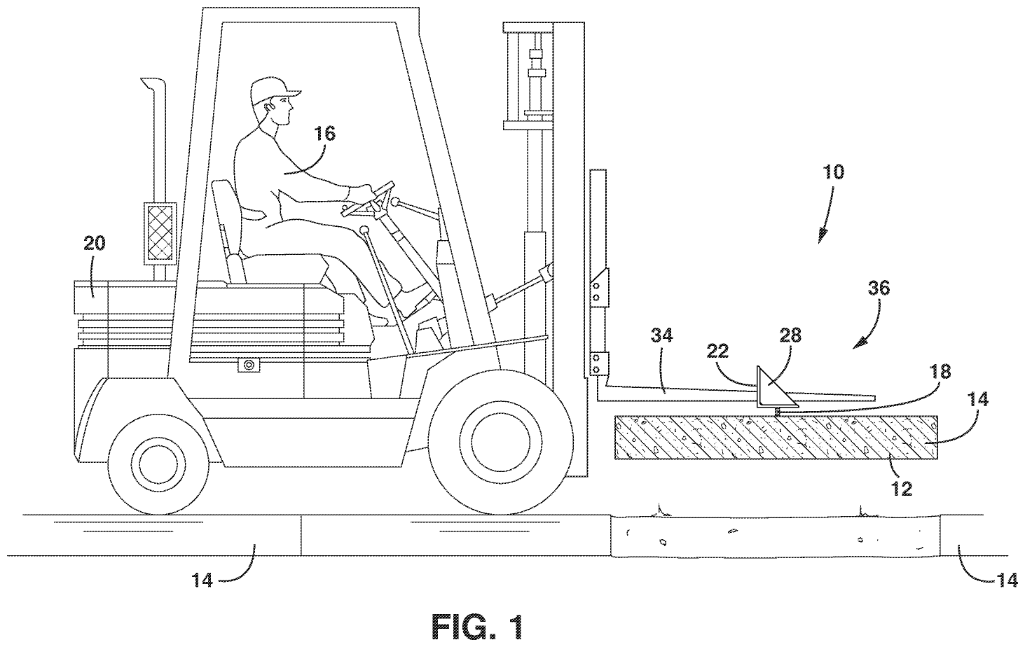

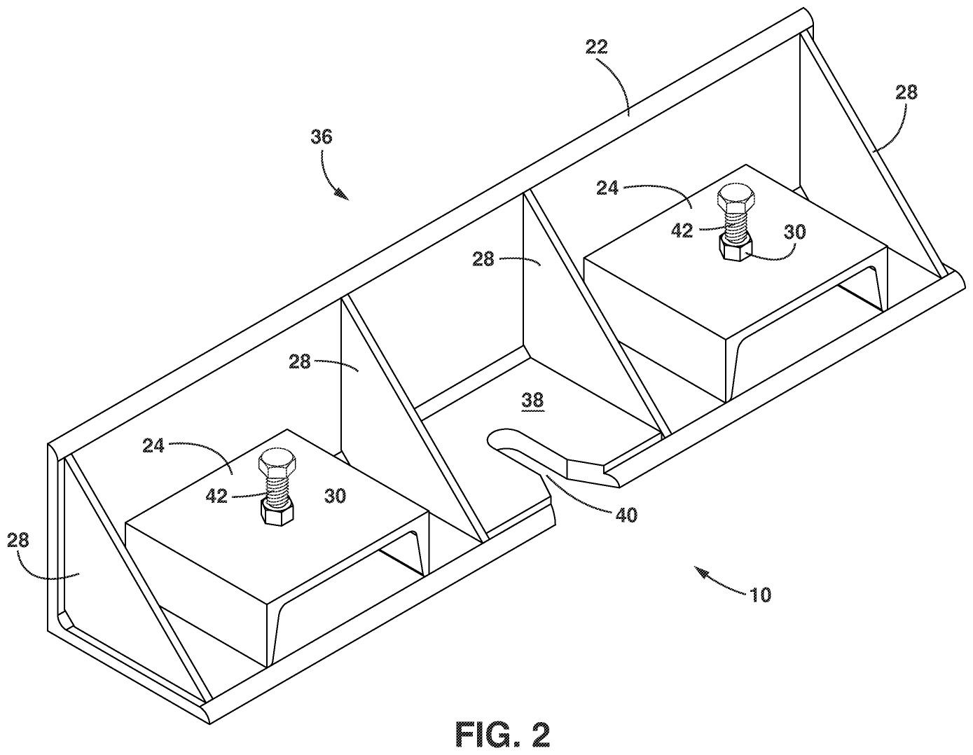

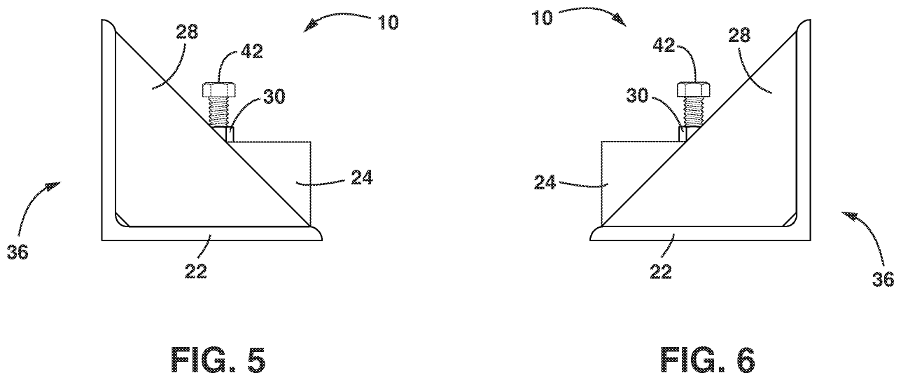

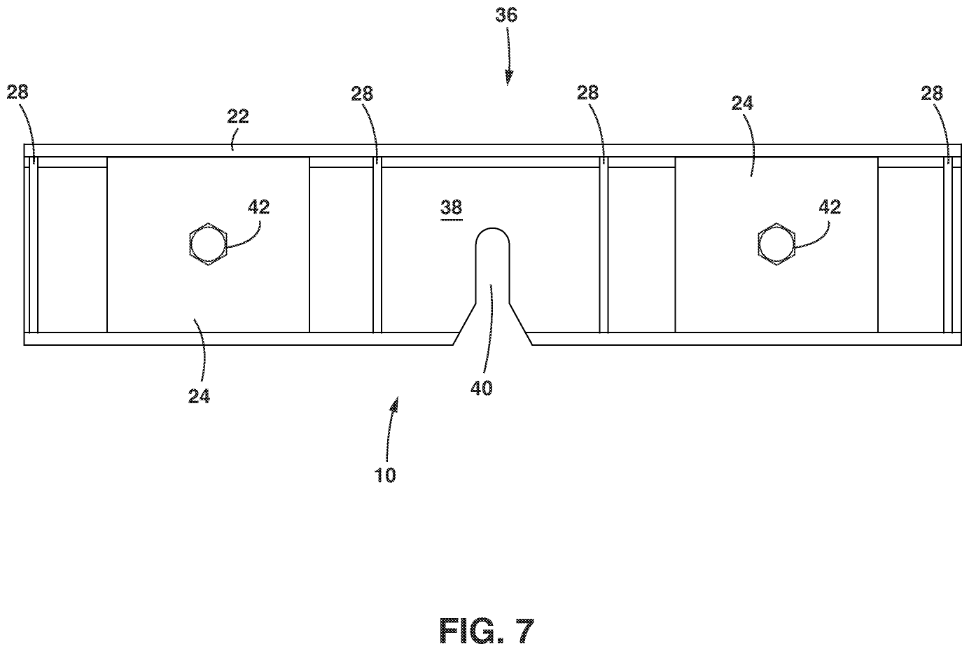

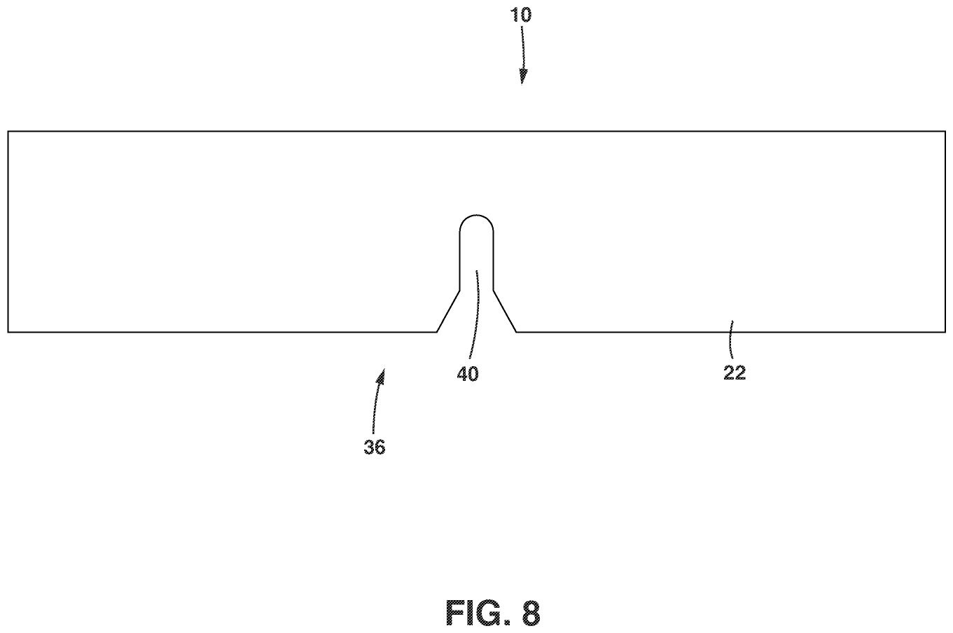

Referring to FIG. 1 through FIG. 13, a concrete removal device and system 10 is provided which can be used for fast, efficient removal of concrete sidewalks, driveways, slabs 12, and other concrete constructions 14, which eliminates the need to break up the slab for removal. A concrete removal device and system 10, according to one embodiment, is used by an operator 16 capable of drilling a concrete slab 12 to set preferably a single anchor bolt 18 therein and driving a forklift 20 equipped with a concrete removal device 10 (such as unit shown in FIGS. 2-8) so that at least one forklift fork 34 slides into and through a channel extending through the device so that the forklift 20 can be used to elevate a concrete slab 12 (as shown in FIG. 1) above the ground surface and to deposit it in a dump truck or dumpster (without having to break the slab into smaller pieces), for hauling away from the removal site. At least one embodiment is described in the following descriptions. Of course, other embodiments can also be construed and constructed without departing from the inventive concepts disclosed herein.

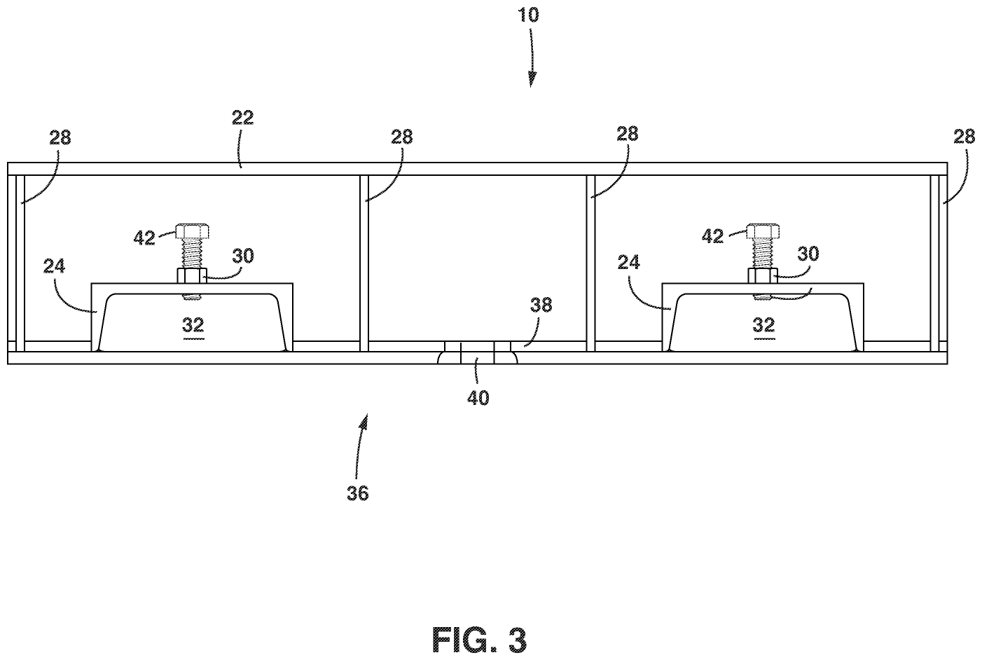

The concrete removal device 10 as referenced in FIG. 1 through FIG. 10 is preferably made of ASTM A 36 grade steel and from a 4-8 inch, or preferably 6 inch by 4-8 inch, or preferably 6 inch by 0.3125 or 0.375 inch angle iron 22 about 24 inches long, or between about 18 inches to about 48 inches in other embodiments. Angle iron 22 may include one or more slots 32 cut in the vertical wall of the angle iron 22 to receive the forklift fork(s) 34, as shown in FIG. 3. One or preferably two channels, such as a C6×10.5 C channel(s) 24 may be fixedly attached to the vertical and horizontal walls of the angle iron 22, as shown, to reinforce the holes 32. Channels 24 may be about 5.25 inches in length along with one or more reinforcement plates 38 measuring about 5.75 inches by 4.875 inches by 0.25 inches thick. These components are welded together with 0.25 inch continuous straight and uniform fillet welds. All joints are welded as access is available.

In addition to the above. Four triangular gussets 28 preferably made from about 5.25 inch by 5.25 inch by 0.25 inch thick 1018 CRS steel, may be affixed to each of the walls of the angle iron 22 to add rigidity thereto angle iron 22. In one embodiment, the channels each have a through hole therein in the web of the channel. Two ½-20 UNF or 1-8 UNF steel hex nuts 30 as well as the gussets 28 may then, along with these components, be welded into the assembly with 0.25 inch continuous straight and uniform fillet welds. That is, a pair of gussets 28 are attached to the angle iron 22 so that the channel 24 sits between the gussets 28. Moreover, the hex nut 30 is welded above the through hole in the channel so that bolt 42 can pass therethrough so that the device 10 may be secured to the forklift forks 35. All joints are welded as access is available.

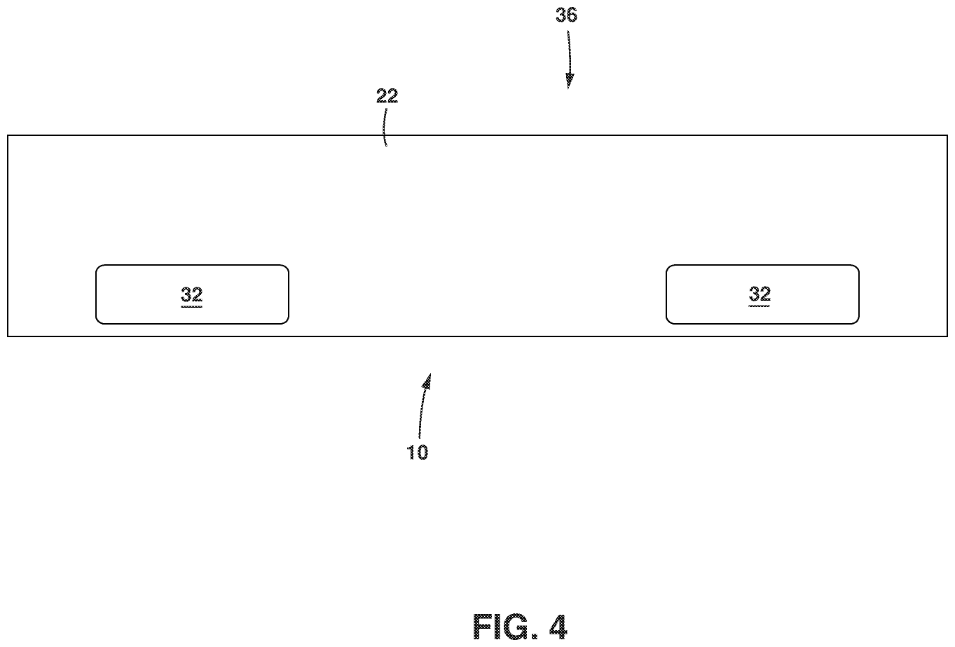

The vertical wall of the angle iron 22 preferably has two holes 32 cut out about 1.75 inches by 5.75 as shown in FIG. 4. The holes 32 accommodating the entry of forklift forks 34 from the rear face and through the channels 24 of the concrete removal device 10.

The central portion of the assembly 36, between the middle gussets 28, has a slot 40 therein extending from about the middle of the horizontal wall of the angle iron 22 through to the outer edge thereof. Preferably, slot 40 flares out about ⅓ of the way from the outer edge of the horizontal wall. Preferably, a reinforcement plate 38 is positioned between the middle gussets, such that the thickness of the horizontal wall of the angle iron 22 is a multiple of the thickness of the wall between the channels. The keyhole like open slot 40 cut extends through both the reinforcement plate 38 and the angle iron 22, as shown in FIG. 2. The slot according to a preferred embodiment measures about 2.375 inches at the front and is about 1 inch wide through the body by about 3.5 inches long, as shown in the drawings. As shown in FIG. 9, the device 10 may be configured with a plurality of outward slots 40 having essentially the same dimensions and being, essentially parallel to each other, each between a pair of gussets 28.

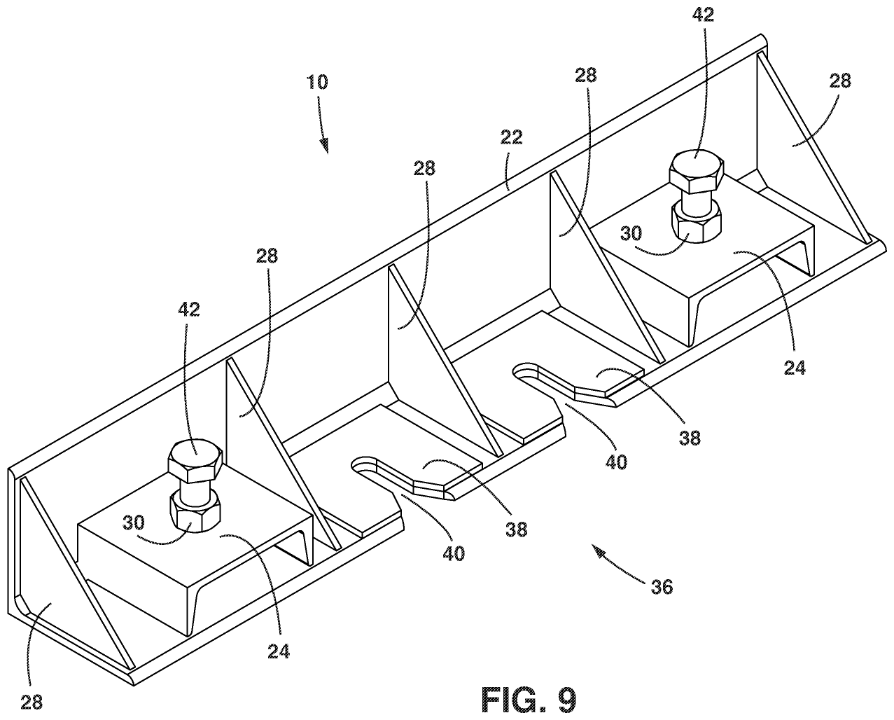

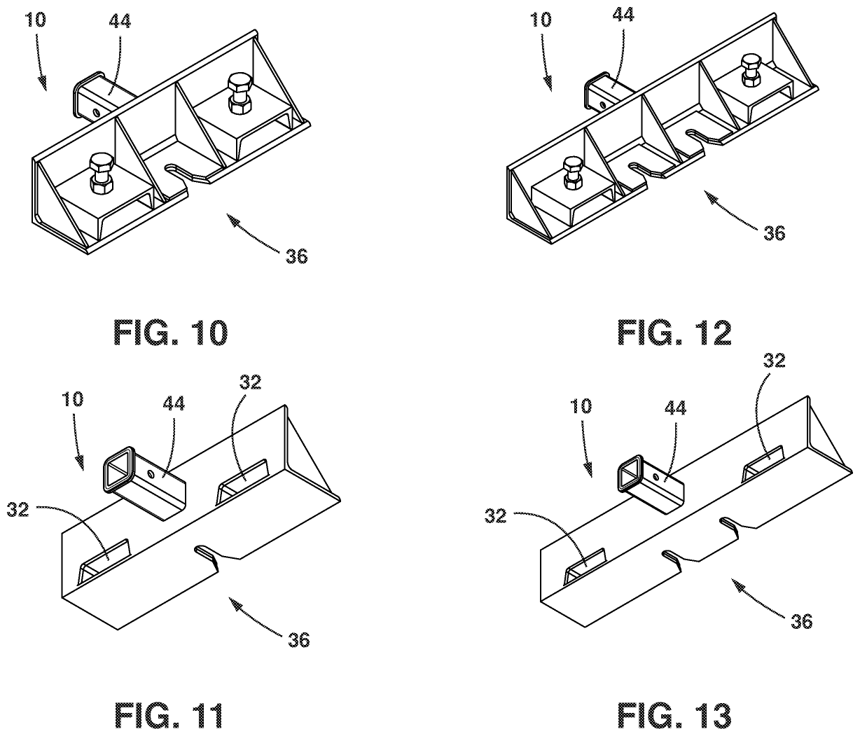

In other embodiments, concrete removal device and system 10 can have a receiver 44 attached to the rear face of the angle iron 22, opposite the slot 40, as shown in FIGS. 10-13, for accommodating a variety of hitches, which receiver 44 may be attached by a continuous welded joint or other means. The receiver 44 is preferably made from ASTM A 36 grade steel tube about 0.25 inches thick with about a 2.125 inch×2.125 inch inside dimension and about 6 inches in length. A receiver 44 can have a lip plate measuring about 1.875 inches×1.875 inches×0.25 inches thick surrounding the front entrance point and about a 0.625 inch hole continuously through the tube, as an access hole for a hitch pin. In this embodiment, the device 10 may be affixed to the forklift from the direction of the slot 40, so that the receiver 44 faces outward from the forklift.

A concrete removal device 10 can be left unfinished or have a surface finish applied by plating, galvanizing, painting, or powder coating to name a few examples.

The device 10 may be used by a laborer by setting an anchor bolt 18, such as a large diameter Tapcon (LDT) Anchor, measuring about 0.625 inches by 4 inches in length, in the center of each concrete slab 12 to be lifted. The bottom of the head of the anchor bolt 18 is positioned about 1 inch above the top surface of the concrete slab 12.

The forklift operator 16 may then position the forks 34 into the holes through the angle iron 22 and slide the forklift forks 34 through the channels 24 of the concrete removal device 10, centering the device on the forks 34. A laborer may then tightens two hex head bolts 42 into the two ½-20 UNF steel hex nuts 30, therewith securing the concrete removal device 10 to the forklift forks 34. The operator 16 then drives the forklift 20, positioning the concrete removal device 10 so that the keyhole like slot 40 receives the shank of the anchor bolt 18. The head of the anchor bolt 18 protrudes above the concrete removal device 10.

As the forklift forks 34 are lifted upward by the operator 16, the concrete removal device 10 engages the underside of the anchor bolt 18 head, lifting the concrete slab 12 from the ground, so that the slab can be moved to a position where it can be dropped into a dump truck or dumpster to be hauled away from the removal site.

While the foregoing invention has been described in some detail for purposes of clarity and understanding, it will be appreciated by one skilled in the art, from a reading of the disclosure, that various changes in form and detail can be made without departing from the true scope of the invention.

What is claimed is:

1. An apparatus comprising:
an angle having a vertical wall and a horizontal wall; and
a plurality of gussets each attached to the vertical wall and the horizontal wall of the angle, along a length thereof,
wherein the vertical wall has a plurality of slots passing therethrough, each configured to receive a forklift fork, wherein the horizontal wall has a slot therein located between the holes in the vertical wall, and wherein the slot in the horizontal wall extends outward from about a center of the horizontal wall to an outer edge thereof.

2. The apparatus of claim 1, comprising a pair of channels attached to the vertical wall and the horizontal wall at the slots in the vertical wall, the channels configured for forklift forks to pass through the slots and through a volume created by the channels and the horizontal wall of the angle.

3. The apparatus of claim 2, wherein each of the channels is located on the angle between a pair of gussets.

4. The apparatus of claim 3, wherein the slot in the horizontal wall is located on the angle between a pair of gussets.

5. The apparatus of claim 4, wherein a thickness of the horizontal wall of the angle between the pair of gussets flanking the slot in the horizontal wall is a multiple of a thickness of the horizontal wall between other pairs of gussets.

6. The apparatus of claim 4, wherein at least one of the channels has therein a means for securing the device to at least one forklift fork.

7. The apparatus of claim 1, wherein the angle has a length of between 18 inches and 48 inches.

8. The apparatus of claim 1, wherein the horizontal wall has a second slot therein located between the holes in the vertical wall, and wherein the second slot in the horizontal wall extends outward from about a center of the horizontal wall to an outer end thereof.

9. The apparatus of claim 8, wherein each of the slot in the horizontal wall and the second slot in the horizontal wall are flacked by a pair of gussets.

10. The apparatus of claim 1, wherein the slot in the horizontal wall flares out toward the outer edge of the horizontal wall.

11. The apparatus of claim 1, comprising a receiver extending outward from the vertical wall in a direction opposite that of the slot in the vertical wall.

12. An apparatus comprising:
an angle having a vertical wall and a horizontal wall;
a plurality of gussets each attached to the vertical wall and the horizontal wall of the angle, along a length thereof; and
a pair of channels attached to the vertical wall and the horizontal wall at the slots in the vertical wall, the channels configured for forklift forks to pass through the slots and through a volume created by the channels and the horizontal wall of the angle,
wherein the vertical wall has a plurality of slots passing therethrough, each configured to receive a forklift fork, wherein the horizontal wall has a slot therein located between the holes in the vertical wall, wherein the slot in the horizontal wall extends outward from about a center of the horizontal wall to an outer edge thereof, and wherein the slot in the horizontal wall is located on the angle between a pair of gussets.

13. The apparatus of claim 12, wherein each of the channels is located on the angle between a pair of gussets.

14. The apparatus of claim 12, wherein a thickness of the horizontal wall of the angle between the pair of gussets flanking the slot in the horizontal wall is a multiple of a thickness of the horizontal wall between other pairs of gussets.

15. The apparatus of claim 12, wherein at least one of the channels has therein a means for securing the device to at least one forklift fork.

16. The apparatus of claim 12, wherein the angle has a length of between 18 inches and 48 inches.

17. The apparatus of claim 12, wherein the horizontal wall has a second slot therein located between the holes in the vertical wall, and wherein the second slot in the horizontal wall extends outward from about a center of the horizontal wall to an outer end thereof.

18. The apparatus of claim 17, wherein each of the slot in the horizontal wall and the second slot in the horizontal wall are flacked by a pair of gussets.

19. The apparatus of claim 12, wherein the slot in the horizontal wall flares out toward the outer edge of the horizontal wall.

20. The apparatus of claim 12, comprising a receiver extending outward from the vertical wall in a direction opposite that of the slot in the vertical wall.
